(19) United States
(12) Patent Application Publication
(10) Pub. No.: US 2008/0245482 A1
(43) Pub. Date: Oct. 9, 2008

(54) Belt for use in forming a core of plies, beads and belts of a urethane tire

(76) Inventors: Richard A. Steinke, Boulder City, UT (US); Gary N. Benninger, West Bloomfield, MI (US)

Correspondence Address: M. REID RUSSELL, 854 WEST 3390 SOUTH, HURRICANE, UT, 84737, US

(21) Appl. No.: 11/732,023

(22) Filed: Apr. 3, 2007

(51) Int. Cl. B29D 30/08

(52) U.S. Cl. 156/408

(57) ABSTRACT

A belt for incorporation into a core of plies and beads formed on a tire core build mandrel where the core is for encapsulating in an elastomeric material, preferably a polyurethane, in a tire formation process, and which belt is formed from like belt sections laid over one another where the one belt section is rotated approximately one hundred eighty degrees around its longitudinal axis with respect to the other, and the belt sections are individually mounted around a tire core build mandrel top whereover a plies has been fitted and with the pair of belt sections ends off-set from one another and are fitted together into a continuous belt. Each belt section is a weave of lateral and longitudinal cotton cords or filaments containing straight, spaced, parallel, taut, Rayon warp cords where the Rayon warp cords or filaments have a crossing angle of forty to sixth degrees respectively, with the stack of a two belt sections forming a tire belt.

### BACKGROUND OF INVENTION

1. Field of the Invention

This invention pertains to an inelastic belt that is for fitting onto a tire core build mandrel whereon a core of plies and beads has been installed, with the belt formed from a pair of woven belt sections that are installed over one another, and with the belt section ends maintained together at spaced intervals around the mandrel of approximately one hundred eighty degrees, providing a continuous belt where its inelastic belt warp cords or filaments are at a desired crossing angle.

2. Prior Art

The present invention is in a belt system for installation over a plies that beads have been fitted to, and with the plies and beads having been installed onto a tire core build mandrel. The tire core build mandrel mounting the core is for fitting into a mold cavity for receiving a flow of an elastomeric material, preferably a polyurethane, that encapsulates the core, forming a tire.

The belt is formed by overlaying two woven belt sections where each belt section has a warp of Rayon cords or filaments and includes cotton cords or filaments as the weave fill, and the one belt section has been turned one hundred eighty degrees around its longitudinal axis with respect to the other. The belt section ends are fitted into a continuous belt section and the abutting belt section ends are spaced approximately one hundred and eighty degrees from one another around the tire core mandrel top or crown surface. The belt sections each have inelastic Rayon warp cords that are set in the belt at an angle of from twenty (20) to thirty (30) degrees to the parallel belt edges, and include separate lateral and longitudinal cotton cords or filaments. Which lateral and longitudinal cotton cords are of different selected diameters and provide a weave that stabilizes and holds the Rayon warp cords straight and in position after the individual belt sections are cut, maintaining the warp cords in straight and parallel to one another. In practice, two belt sections are laid over one another to form the single belt with the belt Rayon warp cords or filaments having a crossing angle of from forty (40) to sixty (60) degrees. In which positioning, the weave of the two different sets of cotton cords or filaments provide for maintaining the positioning of the Rayon warp cords or filaments and separating the layers of warp cords or filaments.

The belt sections are each formed to have a length to encircle the tire core build mandrel, above a plies sleeve fitted thereon, and the belt section ends each have like opposing angles to fit closely together. The belt section ends are fitted together, with the belt sections end junctions of each pair of belts spaced approximately one hundred eighty degrees from one another, around the tire core build mandrel top or crown surface. With the belt or belts encircling the tire core build mandrel, a tire cord is wrapped continuously therearound, completing the assembly of the tire core that can then be fitted into mold cavity to receive a flow of an elastomeric material, preferably a polyurethane material, that encapsulates the core, completing the tire. Which preferred polyurethane material is absorbed into the surfaces of the Rayon warp and cotton cords or filaments and provides a mechanical bond thereto.

A plies sleeve with beads and a Rayon warp cord or filament belt or belts is shown and described in a pending patent applications for spin casting and vacuum forming tires of one of the present inventors, U.S. patent applications entitled: “Improved Method and Apparatus for Forming a Core of Plies, Belts and Beads and for Positioning the Core in a Mold for Forming an Elastomeric Tire”, Ser. No. 10/909,807, filed Aug. 2, 2004; and a “Method and Apparatus for Vacuum Forming an Elastomeric Tire”, Ser. No. 10/936,635, filed Sep. 4, 2004. Which patent applications demonstrate a utilization of a plies sleeve and shows a Rayon cord or filament belt formed on the upper surface of that plies sleeve, extending across a top or tread area of a tire core build mandrel. Additionally, a formation of a tire belt is shown in an earlier U.S. patent application by one of the present inventors entitled, “Method and Apparatus for Forming a Core of Plies, Belts and Beads and for Positioning the Core in a Mold for Forming an Elastomeric Tire”, Ser. No. 10/909,807, filed Aug. 2, 2004. In which tire belt formation, a Rayon cord or filament is laced back and forth between spaced off set teeth of gear plates, with the cord forming an angle of approximately twenty four (24) degrees to the belt sides. In which belt formation, sections of cotton matt material are fitted between the plies surface, and between belt sections and belts and a final section of thin cotton material is installed onto of a final belt in forming the tire core. Further, a recent U.S. patent application by the present inventors entitled, “Belt for use in Forming a Core for Manufacturing an Elastomeric Tire”, filed Jun. 13, 2006, like the invention, also addressed overlapping of belt sections that are each joined at their ends into a continuous belt, and with the belt sections each cut from a rectangular woven section such that inelastic cords of each belt section have an angle of approximately twenty four (24) to twenty six (26) degrees to the belt section edges. Which earlier patent applicant discusses a relationship of the inelastic Rayon warp cords and their interlacing of the cotton filament cords for a selected weave provides for maintaining the integrity of the belt sections after they are cut from the rectangular woven section. In practice, however, it was found that the interlacing of the cotton filament cords with the Rayon warp cords produced some unwanted slack in the Rayon warp cords in a formed belt. To overcome and prevent any slack in the Rayon warp cords of the present invention, as could detract from belt strength, the invention employs a weave where the Rayon warp cords remain straight with selected greater and lesser diameter of cotton filament cords interwoven with each other, supporting but not bending the Rayon warp cords, maintaining weave integrity after the rectangular woven section is cut into the belt sections, and which weave integrity is maintained during the belt sections positioning around the tire core build mandrel, and the belt sections ends fitted together. The finished belt or belts, like the belt or belts shown in the above set out U.S. patent application of the inventors provide a finished belt system that does not require the installation of sections of cotton material, or like separators, between the belt sections and belts.

### SUMMARY OF THE INVENTION

It is a principal object of the present invention to provide a tire belt system where each belt is a stack of two belt sections that are fitted over one another to form a single belt, and where each belt section is formed by cutting it from a woven rectangular belt section that is a weave of inelastic warp cords, preferably Rayon, warp cords, and lesser and greater diameter cotton lateral and longitudinal cords, and where the Rayon warp cords remain straight and unbent in the weave of the lesser and greater diameter cotton cords or filaments, providing for a tight fit of the straight and essentially parallel Rayon warp cords around a tire core build mandrel that a tire core containing the belt sections of the invention is built on.

Another object of the present invention is to provide the tire belt system where each belt is formed from two belt sections that are stocked on one another to form the single belt, where one of the belt sections has been rotated one hundred eighty (180) around its longitudinal axis to the other, and the belt section ends are maintained in butting engagement to one another with the Rayon warp cords under tension, forming a continuous belt around a tire core build mandrel that a tire plies has been mounted on.

Another object of the present invention is to provide a tire belt that is a weave of inelastic Rayon warp cords and lesser and greater diameter lateral and longitudinal cotton cords, where the rectangular weave is held together by the cotton fill cords when belt sections are cut on a bias where the inelastic straight warp cords form angles of from twenty (20) to thirty (30) degrees to the belt section cut edges, and the distance across the belt section is to fit across the width of a tire core build mandrel.

Another object of the present invention is to provide a tire belt formed from a pair of belt sections where the one belt section is rotated one hundred eighty (180) degrees around its longitudinal axis to the other such that the warp cord angle of the two belt sections combine to a warp cord crossing angle of from forty (40) to sixty (60) degrees.

Another object of the present invention is to provide a tire belt that includes a weave of lesser and greater diameter cotton cords and Rayon warp cords that does not require a use of spacing layers between the belt sections, belts or above or below a tire belt.

Still another object of the present invention is to provide a tire belt formed from a pair of belt sections that are cut or otherwise formed from sections of a rectangular weave of lesser and greater diameter cotton cords and Rayon warp cords, where the belt sections are cut at like bias angles to the weave such that the Rayon warp cords are at an angle of from twenty (20) to thirty (30) degrees to the belt section sides.

Still another object of the present invention is to provide a tire belt formed from a pair of like belt sections where the one belt section is rotated one hundred eighty (180) degrees about its longitudinal axis to the other belt section, where the respective different lateral and longitudinal cotton cords have diameters that are selected to allow for a desired spacing distance between the Rayon warp cords when the belt sections are stacked providing for an interaction of the cotton threads in the each of the belt sections weave to maintain the belt section end abutting when the belt section ends are pressed against the plies sleeve surface and against each other.

Still another object of the present invention is to provide a tire belt from belt section where the belt section ends are formed with like opposing angles to fit together and are to be held together when then are pressed to layers of plies below or belt sections holding the belt section ends in positioning, forming a continuous belt section, and where the two overlaying belt sections having their contacting ends spaced approximately one hundred eighty degrees apart around the mandrel top or crown surface, forming a single belt, and are maintained in position by application of a tire cord wound therearound.

Still another object of the present invention is to provide a belt system where a belt is formed by overlaying the two like belt sections, with the one belt section rotated one hundred eighty degrees relative to the other around the belt section longitudinal axis, and the cords that form the belt section weave are Rayon and lesser and greater diameter cotton cords, respectively, that provide for a strong surface bonding with a polyurethane mixture as is preferred to form a tire containing the belt, providing a mechanical lock between the cords surfaces and the cured polyurethane material.

The present invention is in a belt system for installation around a top or crown surface of a tire core build mandrel that a core of plies and beads have been mounted on, forming a core of plies beads and a belt or belts that is encapsulated in an elastomeric tire by casting, molding, vacuum forming, or like methods. The belt or belts of the invention are fitted and maintained over a plies sleeve around the top or crown surface of the tire core build mandrel, and receive a winding of tire cord wound around the mounted belt as a final step informing a tire core that is for placement in a mold wherein an elastomeric material, preferably a polyurethane material, is introduced during the tire molding, casting or vacuum forming process.

The belt sections of the invention are each formed from a section of woven material that has a selected width to allow for its being cut, or otherwise formed, into individual belt sections where the width across each belt section is the width of the top or crown of the tire core build mandrel, above a plies layer. Each belt section is cut or otherwise formed from the section of woven material to where its warp cords or filaments present like angles of twenty (20) to thirty (30) degrees to the belt section sides, and have a weave of cotton lateral and crossing cords or filaments and cotton longitudinal cords that are parallel and spaced equally apart from the straight Rayon warp cords or filaments. Which lateral and longitudinal cords or filaments maintain the Rayon warp cords in position when and after the section of woven material is cut or formed into a belt section. Additionally, the cut belt section edges may, but need not, be treated with an application of an adhesive to further prohibit the belt section cut section edges from unraveling. Each of which belt sections is formed to have a length to fit around the tire core build mandrel on top of the mounted plies sleeve, and the belt section ends are formed to have like opposing angles that, when fitted and maintained together, form a continuous belt that encircles the tire core build mandrel above the plies sleeve. A second belt section, that is like the first belt section, but may be slightly longer and narrower, and is rotated one hundred eighty (180) degrees around its longitudinal axis to the first belt section, is installed on top of the first belt section, forming a belt that has a crossing angle of the warp cords of filaments of from forty (40) to sixty (60) degrees.

The invention provides woven belt sections for assembly in pairs into a continuous belt that fits snugly around a top surface of a tire core build mandrel whereon a plies sleeve has been mounted. The individual belt sections are formed from a weave of Rayon warp and first and second lateral and longitudinal cotton cords or filaments. The Rayon warp cords or filaments preferably have a diameter of from point zero two six (0.026) to zero three zero (0.030) inches to provide approximately fourteen Rayon warp cords per inch, and the lateral and the longitudinal cotton cords that are woven together so as to maintain the Rayon warp cords in a straight taut attitude. Which lateral and longitudinal cotton cords preferably have, respectively, diameters of from point zero ten to point zero one five (0.015) inches and point zero zero seven (0.007) inches, where the lateral cords form seven (7) to ten (10) picks per inch on both the top and bottom of the weave to obtain a desired flow of polyurethane material through the weave during tire formation.

So arranged, the Rayon warp cords are maintained in place in a taut state when the belt sections are bias cut at a preferred angle of twenty four (24) degrees, but may to cut at an angle of from twenty (20) to thirty (30) degrees to the belt sections sides, within the scope of this disclosure.

In practice, the selection of the particularly of the Rayon warp and longitudinal and lateral cotton cords or filaments provide a weave where the integrity of the Rayon warp cords are maintained when cut on the bias across the weave. Thereby, the finished belt sections, when stacked together and onto a plies sleeve surface, create a required spacing distance between the Rayon warp cords or filaments in the belt section and between the belt sections to allow for a free passage of a polyurethane material flow therethrough, encasing the tire core, in the tire formation process. Further, the cotton longitudinal and lateral cords provide fibrous surfaces for gripping surfaces of like cotton cords of belt sections and the plies sleeve weave when pressed together, holding the belt sections in place until a tire cord wrap is wound around the assembled belts. Accordingly, where earlier arrangements of plies sleeve, belts and belt cord wrap have required the inclusion of spacing layers, such as sections of thin cotton material, a spacing layer or layers are not required with the belt arrangement of the present invention. The present invention greatly simplifies tire core assembly in that, to form a belt, a pair of belt sections are individually positioned over one another without a need for a separate spacing layer there between, and are positioned around a tire core build mandrel top surface, directly onto a plies sleeve earlier fitted thereto. The belt sections ends are fitted and pressed together to maintain their positioning to and around the plies sleeve as has been fitted onto the tire core build mandrel. Additionally, within the scope of the present disclosure, the belt section ends, can, but need not be, maintained together as with stitching, clips, or other appropriate arrangement, providing for maintaining each Rayon warp filament in an essential taut straight attitude, providing for spacing provided between the belt sections. Thereafter, a second belt can be fitted over the first belt, as needed, and the assembly is then wound with a continuous tire cord, completing a formation of a tire core for installation in a mold to form a polyurethane tire.

### DESCRIPTION OF THE DRAWINGS

The invention may take physical form in certain parts and arrangement of parts, used to form the belt of the invention that is herein shown as a preferred embodiment and will be described in detail in this specification and illustrated in the accompanying drawings which form a part hereof:

FIG. 1 shows a top plan view of a woven section of material that is a weave of Rayon warp and lateral and longitudinal cotton cords or filaments and is shown as being cut or separated with a round blade that travels along broken lines A, with the formed belt sections ends at the sides of the woven section shown as having like opposing angles, and which belt section ends are for joining into a continuous belts section;

FIG. 2 shows an enlarged side elevation view of a section of a belt section showing the separate parallel taut Rayon warp cords or filaments that are contained in a weave of lateral and longitudinal cotton cords or filaments;

FIG. 3 is a side elevation view of the belt section shown in FIG. 2:

FIG. 4 is an end elevation view of the belt section shown in FIG. 2;

FIG. 5 is a side elevation perspective view of a pair of belt sections of FIG. 1, with the one belt section shown positioned beneath and another positioned above a tire core build mandrel that is shown in broken lines, with the one belt section for positioning over the other and be rotated one hundred eighty (180) degrees along its longitudinal axis, with the belt section shown aligned for bending around a top surface of the tire core build mandrel that has received a plies layer thereover, with the belt section ends to be fitted together, forming continuous belt section, and with the connected belt section ends located on opposite top surfaces of the tire core build mandrel;

FIG. 6, shows a tire core build mandrel that a plies sleeve and beads have been fitted to, and shows a top of the pair of belt sections of FIG. 5 with the belt section ends fitted together, and showing the two belt sections as forming a continuous belt;

FIG. 6A shows an enlarged sectional view taken within the curved line 6A of FIG. 6, showing the crossing angle of the Rayon cords or filaments as being from forty (40) to sixty (60) degrees;

FIG. 7 shows an exploded end side elevation perspective view of a section of a tire core that includes a stack of a pair of belt sections of the invention that encircles the tire core build mandrel of FIG. 6, and has received a wrap of tire cord therearound; and

FIG. 8 shows a profile sectional view of a section of a urethane tire that has been cast, molded, vacuum formed, or otherwise fabricated to contain the tire core of FIG. 7.

### DETAILED DESCRIPTION

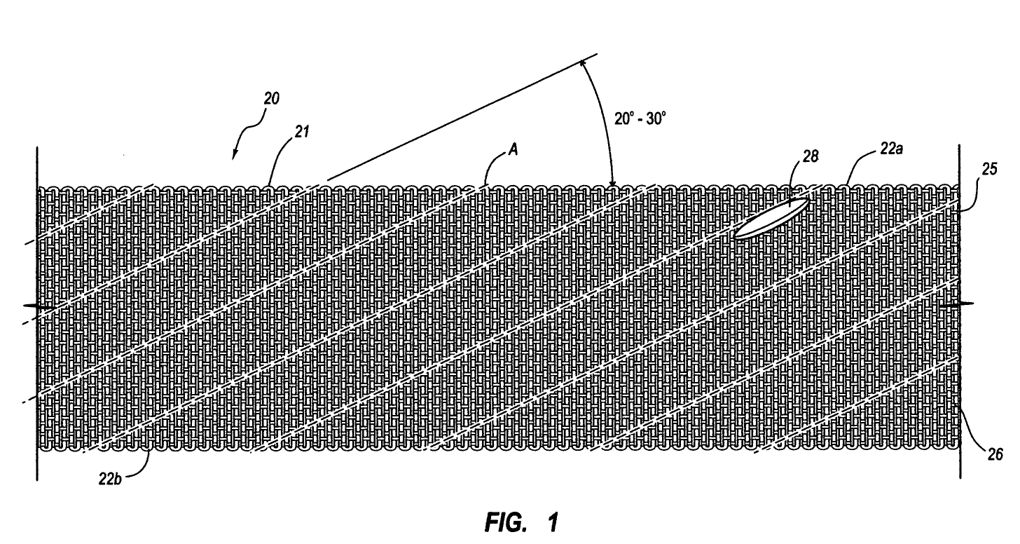

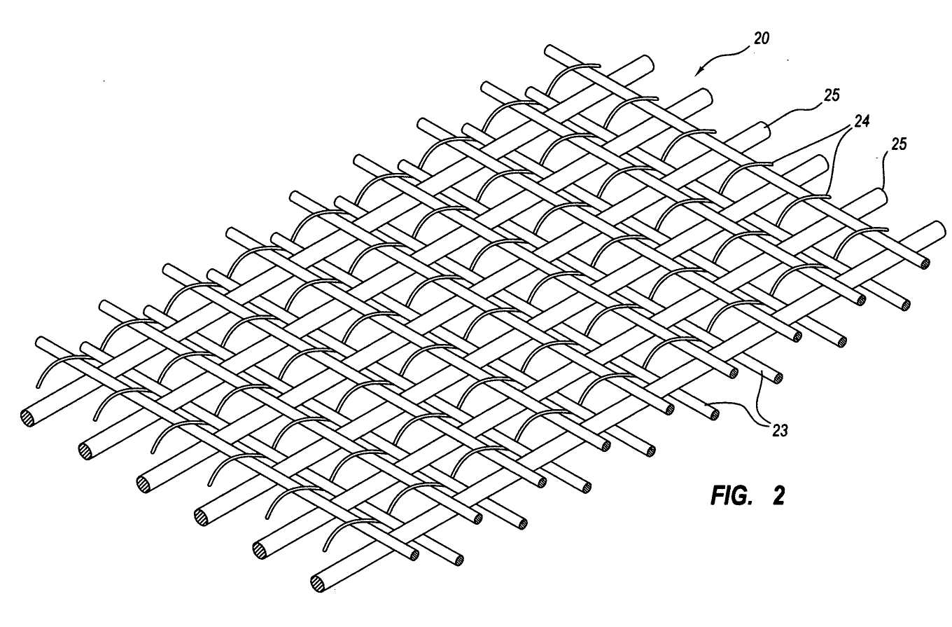

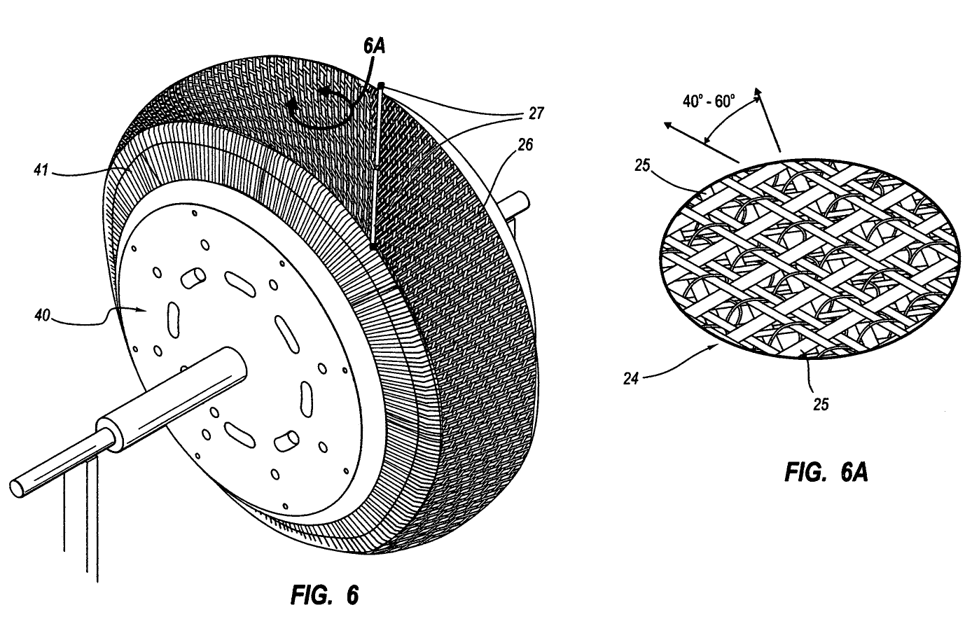

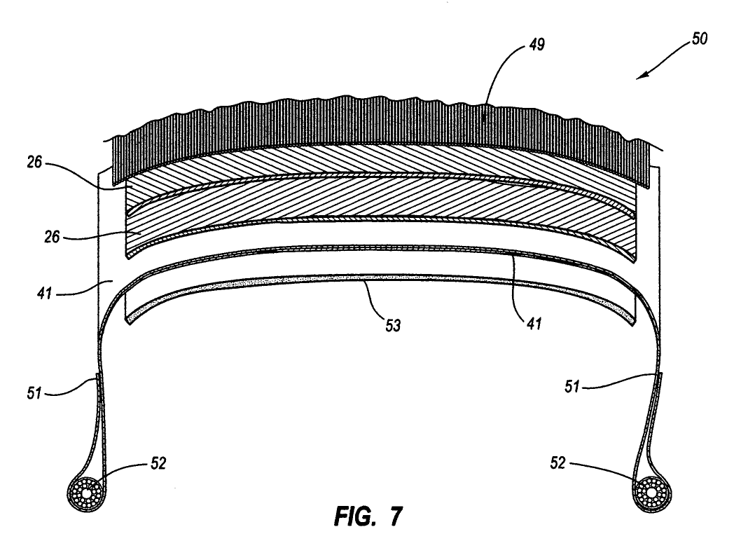

The invention is in a belt 26 that, as shown in FIG. 6, is installed onto a top surface of a tire core build mandrel 40 whereover a plies sleeve 41 has been fitted, as shown also in FIG. 7. The belt 26 is fabricated from a pair of like belt sections 21 that, as shown in FIG. 2, are each a weave of lateral and longitudinal cotton cords 23 and 24, respectively, that contain, in a taut state, parallel, spaced equal distance apart, Rayon warp cords 25, with the belt sections 21, as shown in FIG. 1, cut or formed from a section of the woven material 20. The belt sections 21 are cut, or otherwise formed, as by a cutting disk blade 28, on a bias across the woven material 20, as illustrated by broken lines A, with the weave of cotton cords supporting and stabilizing the taut Rayon warp cords during and after which cutting. Which cutting blade 28 is shown as a disk, that is turned to travel along the broken lines A, cleanly separating the woven material 20 into belt sections 21. Though, it should be understood, another cutting arrangement could be so used, within the scope of this disclosure.

The width of the woven material 20 is selected to allow for the belt sections 21 to be cut on a bias angle that is from twenty (20) to thirty (30) degrees, and is preferably an angle of twenty four (24) degrees, to the side of the woven material 20, and the belt section if of a width and length to fit across and around a top of a tire core build mandrel 40, like that shown in FIG. 6, above a plies 41, that is preferably a plies sleeve. Also, the belt sections 21 may be of slightly different length and width to compensate for the one belt section being fitted over the other, within the scope of this disclosure. Which belt sections 21 have ends 22a and 22b having like opposing angles to fit together into continuous belt 26, with the belt section taut Rayon warp cords or filaments 25 aligning at the belt section 21 ends 22a and 22b. To maintain which belt section ends alignment as each belt section is laid onto, respectively, the plies and then each belt section, in turn, and each belt section is pressed onto the lower layer of plies and belt sections with the cotton lateral and longitudinal cords outer surfaces 23 and 24, respectively, tending to grip one another, holding the belts sections in place. Which gripping action is produced in the cotton cord manufacture where the cotton fibers are wound together into cords with the cords outer surfaces having voids and open fiber ends that tend to engage and hold to one another and hold to other cotton cords surfaces as are pressed thereagainst. In the installation of the belt section 21 onto the mandrel, the belt section ends 22a and 22b are fitted to each other such the Rayon warp cords 25 ends are aligned and the belt section surface is pressed into the layer below/. Thereafter, another belt section or sections 21 fitted thereover for forming one or more belts 26, as shown in FIG. 6.

With the belts 26 installed around the tire mandrel 40 top or crown surface 41, and with the belt section ends 22a and 22b maintained in position, as shown in FIG. 6, a tire cord 49 can be wound around the belt or belts 26, as shown in FIG. 7, the winding proceeding from one belt side to the other, holding the respective belt sections 21 in place and to maintain the abutting positioning of the belt section ends 22a and 22b.

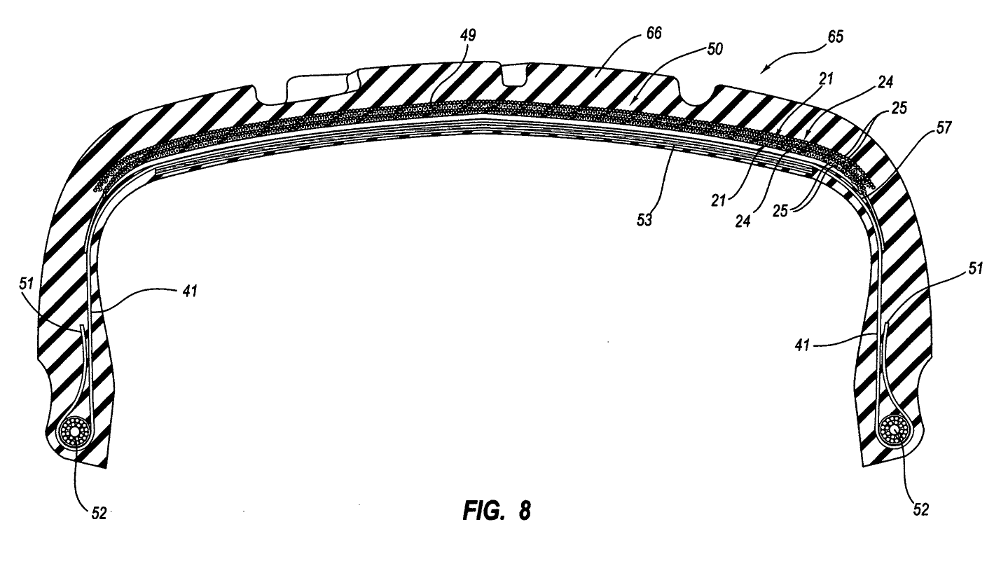

Within the scope of this disclosure, in addition to pressing the belt sections together a mechanical arrangement from maintaining the positioning of the belt section ends 22a and 22b can be employed. For example such arrangement can involve stitching with thread across and along the junction of the belt section ends 22a and 22b, or by an inclusion of joining sections of material, not shown, that are installed across the belt section ends 22a and 22b junctions or clips can be employed that are removed prior to winding the core with tire cord, within the scope of this disclosure. The belt section ends 22a and 22b are thereby coupled, providing a coupling that will resist separation with the addition of a second belt or belts 25 and a winding of the belted tire core build mandrel with tire cord 49, as shown in FIGS. 7 and 8.

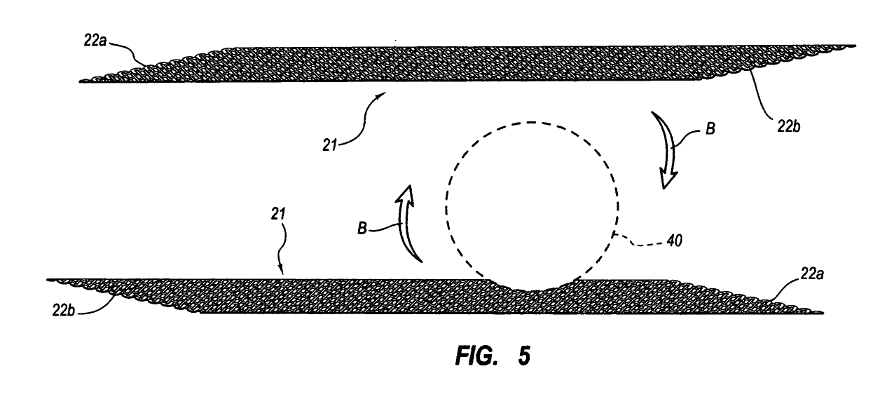

Shown in FIG. 5, to form the belt 26, a pair of belt sections 21 are stacked over one another with the one belt section 21 rotated approximately one hundred eighty (180) degrees along its longitudinal axis to the other, and each belt section 21, in turn, is bent around a top surface of the tire core build mandrel. The belt section ends 22a and 22b are fitted together, as described above, forming a continuous belt section 21. Whereafter, the second belt section 21 is installed over the first, forming the belt 26, as shown in FIG. 6. In which belt section mounting, as illustrated in FIG. 5, the ends 22a and 22b of each belt section 21 are preferably spaced approximately an equal distance around the tire core build mandrel 41 from one another.

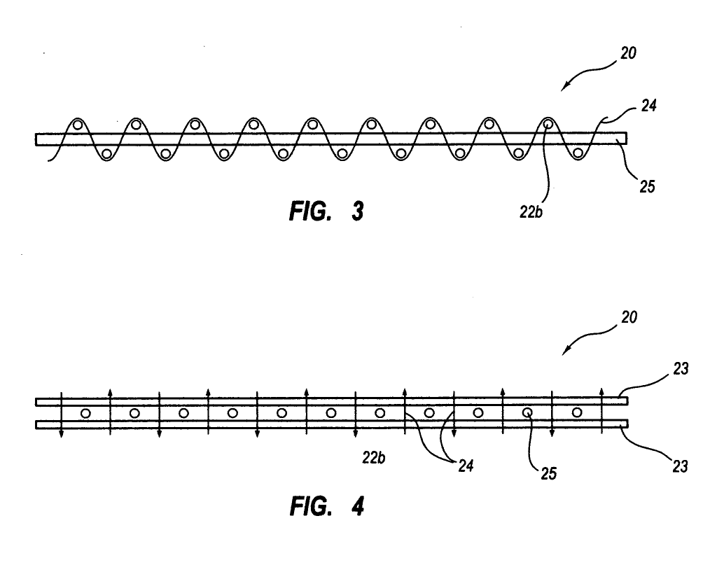

The belt 26, as shown in FIG. 6A, incorporates Rayon warp cords or filaments 25 that preferably cross at a crossing angles of forty eight (48) degrees, but may be at an angle of from forty (40) to sixty (60) degrees, within the scope of this disclosure. FIGS. 2, 3 and 4 show the weave of lateral and longitudinal cotton cords or filaments 23 and 24 as providing for lateral separation of the taut and unbent Rayon cords or filaments 25. Additionally, which cotton cords or filaments, as shown in FIG. 6A, provide also for vertical separation of the Rayon warp cords or filaments 25 in the one belt section 21 from those in the other belt section 21. So arranged, the cotton cords or filaments 23 and 24 provide for maintaining a desired spacing distance between and holding the Rayon warp cords or filaments 25 straight and taut in the formation of the belt 26. In practice, a weave of the invention, as shown in FIGS. 2, 3 and 4, incorporates Rayon cords or filaments 25 that have a preferred diameter of point zero three zero (0.030) inches, the lateral and longitudinal cotton cords or filaments 23 and 24, respectively, have preferred diameters of point zero one five (0.015) inches and point zero zero seven (0.007) inches. In practice a weave density of fourteen (14) threads per inch of the Rayon warp cords or filaments 25 and eight (8) pics per inch of both the weave top and bottom of the cotton cords or filaments have been found to allow for a required flow through of urethane materials as are preferably used in forming a tire over the tire core formed with the belt or belts of the invention. It should, however, be understood the respective Rayon warp cords or filaments 25 can be from point zero two six (0.026) to point zero three zero (0.030) inches, and the lateral cotton cords or filaments 23 can be from point zero one two (0.012) to point zero one eight (0.018) inches, and the longitudinal cotton cords or filaments 24 can be from zero zero five (0.005) to point zero zero nine (0.009) inches, respectively, within the scope of this disclosure. Also, while the preferred Rayon warp cord 25 and lateral and longitudinal cotton cords or filaments 23 and 24, respectively, are as set out above, it should be understood that the number of pics of the respective Rayon and cotton cords or filaments can be varied within the scope of this disclosure with the selected number limited by a requirement to provide sufficient sizes of openings between the cords to allow for a free flow of the urethane materials therethrough, saturating the weave, in a formation of a tire around the tire core that the belt or the belts of the invention are fitted to. Further, a preferred weave for forming the section of material 20 is shown in FIG. 2. Which weave will maintain the Rayon warp cords 25 in a straight taut attitude by a serpentining of the longitudinal cotton cords 24 across and around the lateral cords 23, leaving the Rayon warp cords 25 in a straight taught attitude. Which serpentining of the longitudinal cords 24 around the lateral cords 23 is shown also in FIG. 6A and best in FIGS. 3 and 4.

As set out above, the belt sections 21 of the invention are produced by bias cutting the strips of belt section from the section of woven material 20. Which cutting is illustrated in FIG. 1 as taking place along broken lines A, forming individual belt sections 21 that, with the weave of the invention as described above, retain their dimensional integrity after cutting as well as maintaining the Rayon warp cords 25 in a straight taut state. The belt sections are then wrapped, as shown by arrows B in FIG. 5, around the mandrel top and the junctions of the belt sections ends 22a and 22b are fitted and maintained together, forming a continuous belt 26, as shown in FIG. 6.

FIG. 7 shows an exploded view of a tire core 50 as having a separator layer 53 located between the tire core build mandrel 40, as shown also in FIG. 6, whereon a plies sleeve 41 is fitted. The plies sleeve 41 ends 51, as shown in FIG. 7, have been wrapped around beads 52, and incorporate belts 26 fitted over the plies sleeve. Which tire core 50 has been removed off from the tire core build mandrel 40 of FIG. 6. FIG. 7 illustrates that, with the belt or belts 26, assembled, as set out above, separator layers, such as thin sections of cotton material as have formerly been used in the core systems as set out in the Prior Art section of the present application, are not required. Rather, the utilization of the described cotton cords as the lateral and longitudinal cords or filaments 23 and 24, respectively, to form the weave that contains the straight taut Rayon warp cords 25, and the selected weave density of the section of material 20, provides for both maintaining the positioning of the Rayon warp cords or filaments 25 in their straight taught state, and for their lateral separation in the weave, within the stack of the belt sections 21, and between the plies 41, belt or belts 26 and a tire cord wrap 49.

With the installation of the tire cord wrap 49 the belt section ends 22a and 22b are fixed together, as set out above, producing the tire core 50, that includes one or more belts 26, and is ready for installation into a cavity of a mold as is used to form an urethane tire that is like the tire section shown in FIG. 8.

A urethane tire as incorporates the invention is preferably formed from a polyurethane material in a molding, casting, vacuum forming or other process, and such is shown as tire 65 in FIG. 8. Which tire 65 is shown as including a pair of belts 26 that have each been formed by overlaying two belt sections 21 that are each a weave of individual Rayon warp cords or filaments 25 and the lateral and longitudinal cotton cords or filaments 23 and 24, respectively, and shows the polyurethane material as having flowed through and saturates the tire core, providing a mechanical lock to the plies sleeve material, belts, and beads, forming a homogeneous finished tire 65. Which tire 65, in addition to the tire core 50, includes the polyurethane surface 65 wherein a tread 66 is formed around the top or crown. Which mechanical lock of the polyurethane material to the belt 26 warp cords 25 and cotton lateral and longitudinal cords 23 and 24, respectively, is a result of a use of Rayon as the warp cords or filaments 25 and cotton as the lateral and longitudinal cords or filaments 23 and 24, that tend to absorb the selected polyurethane material and provide a very strong mechanical bond.

While a preferred embodiment of our invention in a tire belt for use in forming a tire core for casting, molding, vacuum forming or otherwise manufacturing a transport tire around a core, has been shown and described herein, it should be understood that variations and changes are possible to belt and belt sections and the belt manufacture on a tire core and the core's use in the formation of a tire, as well as the materials used in tire fabrication, without departing from the subject matter coming within the scope of the following claims, and a reasonable equivalency thereof, which claims we regard as our invention.

We claim:

1. A belt for use in a formation of a tire core that also includes plies and beads where the core is for installation in a mold for forming a polyurethane tire comprising, a pair of identical belt sections for positioning over one another after one belt section has been turned to where junctions of each belt section are across from one another, and each said belt section is a weave of lateral and longitudinal cotton cords or filaments that contain and maintain the individual Rayon warp cords or filaments in a straight taut state to be essentially parallel and form an angle of from twenty to thirty degrees to parallel sides of said belt section, and which said belt section has a width to extend across a top surface of a plies covered tire core build mandrel, a length to extend around said tire core build mandrel, and said belt section ends are fitted and maintained together.

2. The belt for use in a formation of a tire core as recited in claim 1, wherein the belt section ends junctions of each of the two belt sections are positioned on opposite sides of a tire core mandrel top surface whereon the core is being formed.

3. The belt for use in a formation of a tire core as recited in claim 1, wherein the stack of belt sections Rayon warp cords or filaments have crossing angles of from forty to sixty degrees to one another.

4. The belt for use in a formation of a tire core as recited in claim 1 wherein the belt sections are bias cut into equal width sections at an angle of from twenty to thirty degrees to parallel sides of a woven section that is a weave of the lateral and longitudinal cotton cords or filaments that support the straight, taut and essentially parallel Rayon warp cords or filaments.

5. The belt for use in a formation of a tire core as recited in claim 4, wherein the diameter of the Rayon warp cords or filaments used for weaving the section of material is between point zero two six inches and point zero three five inches.

6. The belt for use in a formation of a tire core as recited in claim 4, wherein the diameter of the lateral and longitudinal cotton cords or filaments for use in weaving the section of material are, respectively, between point zero twelve and point zero eighteen inches.

7. The belt for use in a formation of a tire core as recited in claim 1, wherein the weave density of the belt sections is approximately fourteen threads per inch of the Rayon warp cords or filaments and approximately eight pics per inch of the cotton lateral and longitudinal cords or filaments.
